(19) United States
(12) Patent Application Publication
(10) Pub. No.: US 2025/0019181 A1
(43) Pub. Date: Jan. 16, 2025

(54) Method and Device for Conveying and Changing an Orientation of a Piece Product

(71) Applicant: LOESCH Verpackungstechnik GmbH + Co. KG, Altendorf (DE)

(72) Inventors: Daniela Woller, Fürth (DE); Bernhard Bisping, Bamberg (DE); Benedikt Hofmann, Bamberg (DE)

(73) Assignee: LOESCH Verpackungstechnik GmbH + Co. KG, Altendorf (DE)

(21) Appl. No.: 18/710,177

(22) PCT Filed: Nov. 16, 2021
(86) PCT No.: PCT/EP2021/081874

§ 371 Date: May 14, 2024

(51) Int. Cl. B65G 47/244; B65G 47/32; B65G 47/91

(52) U.S. Cl. CPC B65G 47/244; B65G 47/32; B65G 47/914; B65G 2201/0202; B65G 2201/0238

(57) ABSTRACT

A method and a rotating and conveying device for conveying and changing an orientation of a piece product. The method comprises feeding the product onto a product support of the conveying and rotating unit in a predetermined first orientation; changing the orientation from the first orientation to a second orientation by a first driver of the conveying and rotating unit, which first driver is moved in a predetermined conveying direction by the first driver abutting against the product eccentrically with respect to a direction perpendicular to the conveying direction and thereby introducing a rotational impulse; and conveying the product in the second orientation in the conveying direction by a second driver, which is moved in the conveying direction, abutting against the product at at least two points lying on opposite sides, with respect to a center of the product, in the direction perpendicular to the conveying direction.

The invention relates to a method and a device for conveying and changing an orientation or alignment, respectively, of a piece product, in particular a product which has been packaged in a tubular bag.

Packaging with tubular bags is a common packaging technique, in particular in food technology, since this is a hygienic, ecological and cost-effective type of packaging. Chocolate bars are an example of tubular-bag-packaged products. After packaging in the tubular bag, the tubular bag sections, in which the chocolate bars are located, are separated from one another and sealed and are transported further one after the other as piece products by, for example, belt conveyors for further packaging and/or labelling, etc.

In order to further package the products, such as, for example, chocolate bars, in a certain number of pieces, e.g., in a carton, it is advantageous to align the individual tubular-packaged bars in advance, in order to then fill them in a targeted manner into a carton, in order to minimize the packaging volume and to accomplish the packaging in a trouble-free and rapid manner.

In particular, if the bars have a greater length than width, they are transported in the tubular packaging station along their longitudinal direction and are thus packaged in the tubular bag.

For the further packaging in the carton, however, it is advantageous that these tubular-packaged bars are not packaged in their longitudinal direction, as packaged in the tubular bags and transported further, but are transported transversely, i.e., along their short side, to the packaging station for the packaging in the carton.

For this purpose, the orientation of the piece products has to be changed from a longitudinal orientation in the transport direction to a transverse orientation in the transport direction. In the prior art, this has been done up to now, for example, via grippers, in order to achieve process reliability. These grippers grip, for example, a plurality of successive piece products, which have been packaged by means of tubular bags, from a conveying device and transfer them in the same orientation to a further conveying device, the conveying direction of which, however, is at a right angle to the original conveying direction. Thus, the orientation of the products is now favorable for packaging, but such a method, due to the use of controlled handling devices, is associated with high cost expenditure. In addition, more space is consumed for the entire packaging plant in the production site due to the right-angled transport course.

The invention is thus based on the object of providing a method and a device for conveying and changing an orientation of a piece product, which, in a process-reliable and economical manner, brings the piece products into a favorable orientation for packaging and in addition consumes less space in the production site.

The object is achieved by a method according to claim 1 and a conveying and rotating unit according to claim 8 or 9 as well as a packaging plant according to claim 15. Advantageous further developments are contained in the dependent claims.

According to one aspect of the invention, a method for conveying and for changing an orientation of a piece product contains the steps:
feeding the product onto a product support of a conveying and rotating unit in a predetermined first orientation;
changing the orientation of the product from the first orientation in the direction of a second orientation by means of a first driver of the conveying and rotating unit, which first driver is moved in a predetermined conveying direction, by the first driver abutting against the product eccentrically with respect to a direction perpendicular to the conveying direction and thereby introducing a rotational impulse into the product; and
conveying the product in the second orientation in the conveying direction by abutting and resting of a second driver, which is moved in the conveying direction, against the product at at least two points of the product lying on opposite sides, with respect to a center of the product, in the direction perpendicular to the conveying direction.

By introducing the rotational impulse into the piece product by means of the first driver, in that the latter abuts against the product eccentrically, the orientation of the product can be simply changed. The eccentrical abutment means that the abutment by means of the first driver takes place in a direction which is not directed toward the center of mass of the product, such that the product can be rotated when the rotational impulse is introduced.

Since the product does not lie statically on the product support of the conveying and rotating unit, but is applied to the product support at a certain basic speed, it is advantageous to set a corresponding speed at which the first driver abuts against the piece product, in order to introduce a suitable rotational impulse into the product, such that the product rotates to a sufficient extent, but without transitioning into a swirling movement.

The product, which is thus rotated to a sufficient extent, is then stabilized in the second orientation by the second driver via the at least two points lying on opposite sides with respect to a center of the product and is conveyed further in this second orientation. The position of the two points with respect to the center of the product is in turn based on the center of mass which usually lies in the center in the case of such products.

It is thus possible to change the orientation of the piece product in a simple and process-reliable manner, preferably by substantially 90°.

In an advantageous embodiment of the method, a defined frictional force is applied to the product during the change of the orientation or during the conveying by means of the product support, on which the product rests during the change of the orientation and the conveying, in order to brake the rotational impulse or to hold the product in its position on the second driver, respectively.

By applying the defined frictional force, it is possible, despite a high necessary speed of the product in order to achieve an economical throughput and a relatively high rotational speed in order to rotate the product within a short distance, so that it is not necessary to excessively increase the length of the product support, to carry out and maintain the change of the orientation of the product in a process-reliable manner.

According to a further advantageous embodiment of the method, the frictional force is differently preselected, preferably adjustable, along a conveying distance on the product support.

As a result, the necessary frictional force can be adapted to the instantaneous state of movement of the product in order to further optimize the method with respect to the economical throughput and the short distance within which the product rotates.

In a further advantageous embodiment of the method, the product is taken over and conveyed further in the second orientation by a further conveying unit.

In this case, it is possible to transport the product further in the orientation suitable for the packaging to a packaging station without the transport direction having to be changed, such that a layout of a packaging plant has a smaller space requirement.

In a further advantageous embodiment of the method, a conveying speed of the further conveying unit is higher than a conveying speed of the conveying and rotating unit.

This enables a process-reliable takeover of the product since otherwise uncontrolled movements of the product can occur during the takeover.

According to a further advantageous embodiment of the method, a plurality of first drivers and a plurality of second drivers are provided fastened on a circulating belt and a plurality of products are conveyed simultaneously by a circulating movement of the belt and their orientation is changed.

The use of the circulating belt with the drivers improves the economic throughput since continuous conveying and changing of the orientation at a high speed is made possible.

In a further advantageous embodiment of the method, the second orientation encloses an at least approximately right angle to the first orientation.

The favorable layout of the packaging plant is thereby ensured since the packaging sequence can take place in a straight line.

According to a further aspect of the invention, a conveying and rotating unit has a driver transport unit and a product support for carrying out the method. The product support is designed such that the piece-like product slides thereon in a predetermined conveying direction, and the driver transport unit is arranged above the product support and has at least one first driver and one second driver which are preferably simultaneously movable in the conveying direction and facing the product support, wherein the at least one first driver and the at least one second driver each have an active surface which is designed to come into contact with the product. The at least one first driver and the at least one second driver are arranged next to one another on the driver transport unit in a width direction of the product perpendicular to the conveying direction, and the first driver has a surface section of its active surface which is arranged offset in the conveying direction with respect to each surface section of the active surface of the second driver (10), in particular lies in front of each surface section of the active surface of the second driver in the conveying direction.

With this conveying and rotating unit, it is possible to change the orientation of the piece product in a simple and process-reliable manner since no additional complex grippers and controls are required.

According to another aspect of the invention, a conveying and rotating unit has a driver transport unit and a product support, wherein the product support is designed such that the piece-like product slides thereon in a predetermined conveying direction. The driver transport unit is arranged above the product support and has at least one first driver and at least one second driver which are simultaneously movable in the conveying direction and facing the product support, wherein the at least one first driver is arranged on the driver transport unit such that it is designed, during its movement in the conveying direction, to abut against the product resting on the product support in the first orientation such that its orientation changes to the second orientation by introducing the rotational impulse, and the at least one second driver is arranged on the driver transport unit such that it is designed, during its movement in the conveying direction, to abut against at least two points lying on opposite sides, with respect to a center of the product in the second orientation, in a direction perpendicular to the conveying direction.

By means of this device, by introducing the rotational impulse into the piece product by means of the first driver, the orientation of the product can be simply changed from the first orientation to the second orientation. The product, which is thus rotated, is then stabilised in the second orientation by the second driver via the two points lying on opposite sides with respect to a center of the product and is conveyed further in this second orientation. The position of the two points with respect to the center of the product is in turn based on the center of mass which usually lies in the center in the case of such products.

Also in this embodiment, the process-reliable change of the orientation of the product and conveying of the product is easily possible.

In a further advantageous embodiment of the conveying and rotating unit, the product support has at one end a predetermined receiving region in which the product which is fed to the conveying and rotating unit rests on the product support in the first orientation, wherein a width of the receiving region is defined over a width of the product in a width direction perpendicular to the conveying direction, and the first driver is attached to the driver transport unit such that it has a surface section abutting against the product, which surface section leads in the conveying direction and is situated in a section of the receiving region between a center in the width direction and an edge of the receiving region in the direction of a boundary of the product support, which boundary is situated closer to the receiving region, along the conveying direction.

By means of the surface section abutting against the product, which surface section is situated in the section of the receiving region between the center in the width direction and the edge of the receiving region in the direction of the boundary of the product support, which boundary is situated closer to the receiving region, along the conveying direction, it is ensured that by means of the surface section, which is configured for example as a pin, which is preferably oriented substantially vertically, and which therefore generates only a line contact with the product, the rotational pulse is introduced into the product in a process-reliable manner.

According to a further advantageous embodiment of the conveying and rotating unit, the driver transport unit has a circulating belt on which a plurality of first drivers and a plurality of second drivers are arranged.

By means of this embodiment, a high throughput of products and, associated therewith, an economic use is possible without complex actuators and control devices having to be used.

In a further advantageous embodiment of the conveying and rotating unit, a plurality of first and a plurality of second drivers are provided, and in each case a first and a second driver are formed integrally.

By means of the integral formation, an economic production of the drivers, and thus of the conveying and rotating unit, is possible.

In a further advantageous embodiment of the conveying and rotating unit, the product support has a device which is configured to provide a different frictional force between the product support and the product along the conveying direction.

As a result, the necessary frictional force can be adapted to the instantaneous state of movement of the product in order to further optimize the method with respect to the economical throughput and the short distance within which the product rotates.

In a further advantageous embodiment of the conveying and rotating unit, the device to provide the different frictional force along the conveying direction has openings in the product support which are preferably connected to a vacuum system.

The vacuum system and the arrangement and number and size of the openings in the product support are configured such that the use of the vacuum system makes it possible to set the different frictional force along the conveying direction and is preferably configured such that the product does not lift off from the product support even at high conveying speeds.

According to a further aspect of the invention, a packaging plant comprises the conveying and rotating unit, a conveying unit which is designed to feed the product in the first orientation onto the product support, and a further conveying unit which is designed to receive the product in the second orientation.

The favorable layout of the packaging plant is thereby ensured with a suitable transport of the product towards the conveying and rotating unit and a suitable transport away from the conveying and rotating unit since the packaging sequence can take place in a straight line.

The invention is explained in more detail below on the basis of exemplary embodiments with reference to the accompanying drawings.

In particular,

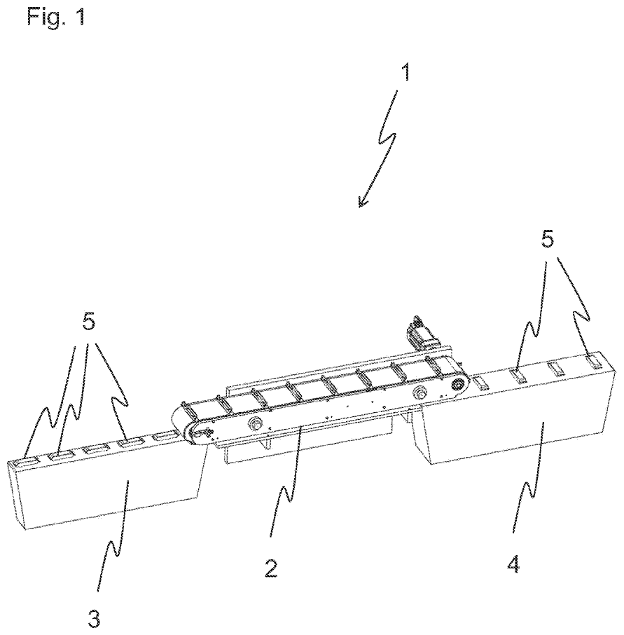

FIG. 1 shows a perspective view of a part of a packaging plant with a conveying and rotating unit according to the invention;

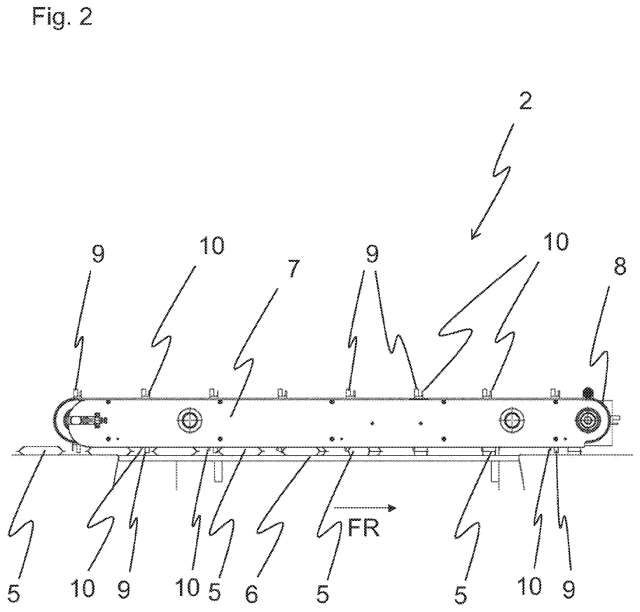

FIG. 2 shows a side view of the conveying and rotating unit;

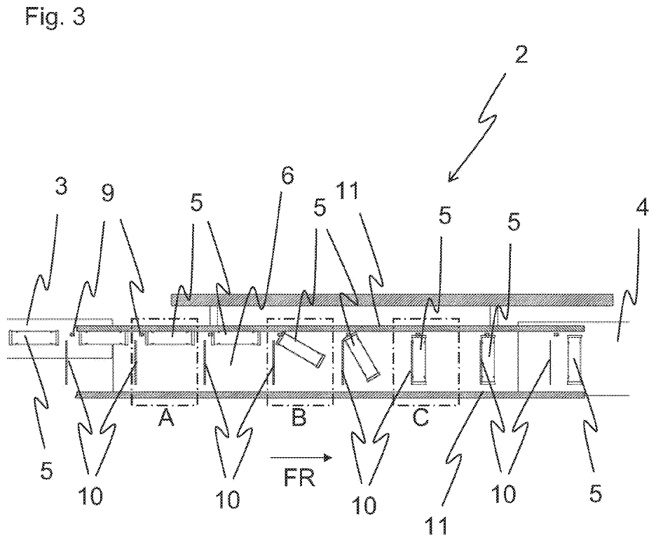

FIG. 3 shows a plan view of a product support of the conveying and rotating unit, in which a driver transport unit is hidden for better illustration;

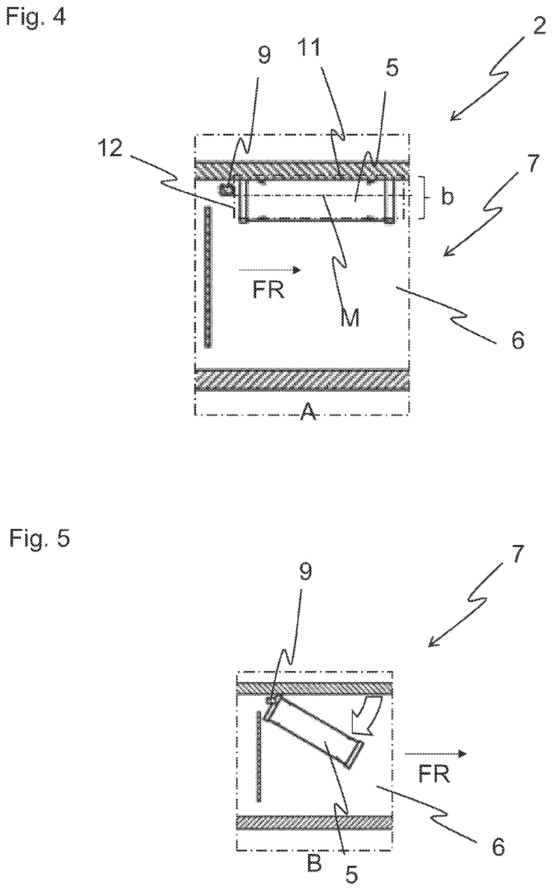

FIG. 4 shows a greatly enlarged view of a detail from FIG. 3 in a situation before a first driver abuts against a product;

FIG. 5 shows an enlarged view of a detail from FIG. 3 during a rotation of the product; and

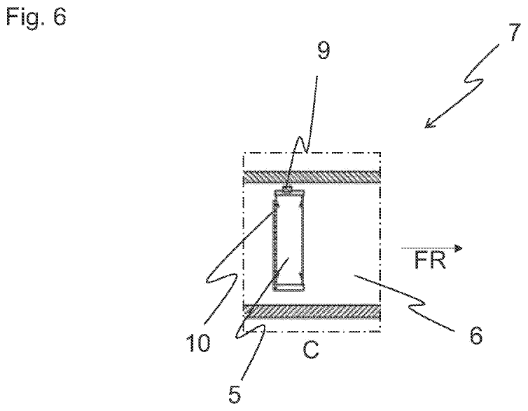

FIG. 6 shows an enlarged view of a detail from FIG. 3 during a conveying of the product.

FIG. 1 shows a perspective view of a part of a packaging plant 1. The packaging plant 1 comprises a conveying and rotating unit 2 as well as a conveying unit 3 and a further conveying unit 4.

The conveying unit 3 feeds piece products 5, for example chocolate bars packaged in tubular bags, in a first orientation to the conveying and rotating unit 2. As can be seen from FIG. 1, the piece products 5 are oriented in the first orientation such that they are transported in the longitudinal direction, i.e., with a leading short side, a so-called “short side leading”.

The further conveying unit 4 takes over the piece products 5 from the conveying and rotating unit 2 in a second orientation and leads them away from the conveying and rotating unit 2. The second orientation corresponds to an orientation in a transverse direction, i.e., with a leading long side, namely a so-called “long side leading”.

It should be noted that, for reasons of a clear illustration, not all products are provided with a reference sign, here 5.

FIG. 2 shows a side view of the conveying and rotating unit 2. The conveying and rotating unit 2 comprises a product support 6 and a driver transport unit 7. The product support 6 is designed such that the piece-like product 5 slides thereon in a predetermined conveying direction FR. The product support 6 further comprises a device to provide a different frictional force between the product support 6 and the product 5 along the conveying direction FR. This device contains a surface coating of the product support 6 which has different coefficients of friction in different sections of the product support 6 along the conveying direction. In an alternative embodiment, openings in the product support 6 and a vacuum system can also be provided. Via the size and number of the openings and operating parameters of the vacuum system, the different frictional force can then be provided by the set negative pressure which sucks the product via the holes onto the product support 6.

The driver transport unit 7 is arranged above the product support 6 and comprises a circulating belt 8. On the circulating belt 8, a plurality of first drivers 9 and a plurality of second drivers 10 are arranged which are simultaneously movable in the conveying direction FR and face the product support 6. Here too, for reasons of clarity, not all products and drivers are provided with a reference sign. In alternative embodiments, the first drivers 9 and the second drivers 10 can also be attached, for example, to a circulating chain or a reciprocating cylinder and/or a number of the first driver 9 and the second driver 10 other than that shown can be provided as long as at least one first driver 9 and one second driver 10 are present.

FIG. 3 shows a plan view of the product support 6 of the conveying and rotating unit 2, in which the driver transport unit 7 (FIG. 2) is hidden for better illustration. FIG. 3 shows a snapshot which represents the products 5 in the different states of their conveying and rotation. In FIG. 3, from left to right, namely in the conveying direction FR, the product 5 is fed in its first orientation “short side leading” to the product support 6 and is then, as described below, rotated by the first driver 9 and the second driver 10 to the second orientation “long side leading” and conveyed further in the second orientation in the conveying direction FR.

The product support 6 comprises side guides 11 which prevent the products 5 from falling down laterally from the product support 6. In alternative embodiments, the side guides 11 are not provided. Further, the product support 6 is oriented such that the conveying direction FR corresponds to a direction in which the products 5 are transported on the conveying unit 3 and the further conveying unit 4. In alternative embodiments, the conveying unit 3 and the further conveying unit 4 are oriented in the same direction and the driver transport unit 7 encloses an angle with the conveying unit 3 and the further conveying unit 4, so that the packaging plant is designed such that the conveying direction FR encloses an angle to a conveying direction on the conveying unit 3 and the further conveying unit 4.

FIG. 4 shows a greatly enlarged view of a detail A from FIG. 3 in a situation before the first driver 9 abuts against the product 5. At one end, the product support 6 comprises a predetermined receiving region 12 in which the product 5 which is fed to the conveying and rotating unit 2 rests on the product support 6 in the first orientation. A width b of the receiving region 12 is defined over a width of the product 5 in a width direction perpendicular to the conveying direction FR and corresponds in particular to the width of the product 5. The first driver 9 is attached to the driver transport unit 7 such that it has a surface section abutting against the product 5, which surface section leads in the conveying direction FR, namely a so-called active surface. Since the first driver 9 in this embodiment is provided with a rectangular cross section, the surface section abutting against the product 5 thus corresponds to the entire front surface of the driver 9. In an alternative embodiment in which the driver 9 is provided, for example, with a cylindrical cross section, the surface section abutting against the product 5 corresponds to a point or a line depending on the precise embodiment of the product 5. This surface section abutting against the product 5 is situated in a section of the receiving region 12 between a center M in the width direction and an edge of the receiving region 12 in the direction of a boundary of the product support 6, which boundary is situated closer to the receiving region 12. This boundary corresponds in this embodiment to the side guide 11 but can also correspond in the alternative embodiments without the side guide 11 to an end edge of the product support 6. In this definition, it is assumed that the product 5 has a center of mass which lies in the center M in the width direction.

In further alternative embodiments, the surface section of the first driver 9 abutting against the product 5 can also be situated in a section of the receiving region 12 between the center M of the width direction and an edge of the receiving region 12 in the direction of a boundary of the product support 6, which boundary is situated further away from the receiving region 12, as long as a rotational impulse is introduced by an abutment of the first driver 9 against the product 5 and there is sufficient space to carry out a rotation to the second orientation.

FIG. 5 shows an enlarged view of a detail from FIG. 3 during a rotation of the product 5.

This view shows a situation in which the first driver 9 abuts with its active surface against the product 5 lying on the product support 6 and comes into contact. The first driver 9 is arranged on the driver transport unit 7 in such a way that, during its movement in the conveying direction FR, it abuts against the product lying on the product support 6 in the first orientation in such a way that the orientation thereof changes toward the second orientation by introducing the rotational impulse.

FIG. 6 shows an enlarged view of a detail from FIG. 3 during a conveying of the product 5.

This view shows a situation in which the second driver 10 transports the product 5 lying on the product support 6 in the conveying direction FR. For this purpose, the second driver 10 is arranged on the driver transport unit 7 in such a way that, during its movement in the conveying direction FR, it abuts with its surface section abutting against the product 5, the so-called active surface, in such a way that, during its movement in the conveying direction FR, it transports the product 5 in the second orientation further in the conveying direction FR. The active surface here is the entire surface of the second driver 10 facing the product 5. In alternative embodiments, the active surface consists of at least two points which abut against the product 5 in such a way that the second orientation is maintained or produced. These two points are selected in such a way that they lie on opposite sides of the center with respect to a center of the product 5, wherein it is in turn assumed that the center of mass is situated in the center of the product 5.

The first driver 9 and the second driver 10 are arranged next to one another on the driver transport unit 7 in a width direction perpendicular to the conveying direction FR. Here, a surface section of the active surface of the first driver 9 lies in front of each surface section of the active surface of the second driver 10 in the conveying direction FR. The first driver 9 and the second driver 10 are illustrated here as separate drivers. In alternative embodiments, the first driver 9 and the second driver 10 can be formed integrally. In a further alternative embodiment, the surface section of the active surface of the first driver 9 is not arranged in front of each surface section of the active surface of the second driver 10, but offset with respect thereto in the conveying direction FR.

In operation, for conveying and changing the orientation of the piece product 5, the product 5 is first fed onto the product support 6 of the conveying and rotating unit 2 in the predetermined first orientation, wherein the first orientation corresponds to the so-called “short side leading” orientation.

The change of the orientation of the product 5 from the first orientation to the second orientation takes place by means of the first driver 9 of the conveying and rotating unit 2, which first driver is moved in the predetermined conveying direction FR, by the first driver 9 abutting against the product 5 eccentrically with respect to the direction 25 perpendicular to the conveying direction FR and thereby introducing a rotational impulse into the product 5, which can take place when the center of mass of the product 5 is located centrally.

The product 5 is then conveyed further in the conveying direction FR in the second 30 orientation by abutting of the second driver 10, which is moved in the conveying direction FR, against the product 5 at at least two points lying in the direction perpendicular to the conveying direction FR. The distance between the first driver 9 and the second driver 10 in the conveying direction FR and the speed of the drivers 9. 10 in the conveying direction FR are therein determined empirically such that the second driver 10 can actually abut against the product 5 such that it remains in the second orientation and can be conveyed further.

During the change of the orientation, i.e. during the rotation, a defined frictional force is applied to the product 5 by means of the product support on which the product rests during the change of the orientation and the conveying. This frictional force is produced by a suitable selection of a material and a surface structure of the product support 6 in order to achieve a desired coefficient of friction in conjunction with the properties of the product 5. The coefficient of friction of the product support 6 is constant over the length of the product support 6, but can also be selected differently in alternative embodiments in order to be better suited for the respective situation. In further alternative embodiments, the defined frictional force is applied by means of openings in the product support 6 and a vacuum system, wherein a negative pressure is set at the openings which can be changed as a function of the selected conveying speed and as a function of the product weight.

A plurality of products 5 are conveyed by a plurality of first drivers 9 and a plurality of second drivers 10, which are fastened on the circulating belt 8, and their orientation is changed. In this case, the second orientation and the first orientation enclose an at least approximately right angle, such that a layout of the entire packaging plant can be designed as space-saving as possible, namely straight. The distance of the first drivers 9 from one another and the distance of the second drivers 10 from one another are matched to the distance of the products supplied to the conveying and rotating unit 2 in the first orientation.

After the rotation and conveying of the products 5 in the conveying and rotating unit 2, the products 5 are taken over in the second orientation by the further conveying unit 4. A conveying speed of the further conveying unit 5 is higher than the conveying speed of the conveying and rotating unit 2 in the conveying direction FR. Alternatively, the conveying speed of the further conveying unit 4 corresponds to the conveying speed of the conveying and rotating unit 2 in the conveying direction FR.

Although the present invention has been described with reference to certain features and embodiments, it is obvious that various modifications and combinations can be made thereto without departing from the spirit and scope of the invention. The description and the drawings are accordingly to be considered merely as an illustration of the invention, as it is defined by the accompanying claims, and are intended to cover all modifications, variations, combinations or equivalents which fall within the scope of application of the present invention.

### LIST OF REFERENCE NUMERALS

1 packaging plant
2 conveying and rotating unit
3 conveying unit
4 further conveying unit
5 product
6 product support
7 driver transport unit
8 circulating belt
9 first driver
10 second driver
11 side guide
12 receiving region
b width
FR conveying direction
M center

What is claimed is:

1. A method for conveying and for changing an orientation of a piece product, comprising the steps of:
feeding the product onto a product support of a conveying and rotating unit in a predetermined first orientation;
changing the orientation of the product from the predetermined first orientation to a second orientation by means of a first driver of the conveying and rotating unit, which wherein the first driver is moved in a predetermined conveying direction, by the first driver abutting against the product eccentrically with respect to a direction perpendicular to the conveying direction and thereby introducing a rotational impulse into the product; and
conveying the product in the second orientation in the conveying direction by abutting of a second driver, which is moved in the conveying direction, against the product at at least two points lying on opposite sides, with respect to a center of the product, in the direction perpendicular to the conveying direction.

2. The method according to claim 1, wherein
a defined frictional force is applied to the product during the change of the orientation or during the conveying by the product support, on which the product rests during the change of the orientation and the conveying, in order to brake the rotational impulse or to hold the product in its position on the second driver, respectively.

3. The method according to claim 2, wherein
the frictional force is differently preselected along a conveying distance on the product support.

4. The method according to claim 1, further comprising the step of:
receiving and conveying further the product in the second orientation by a further conveying unit.

5. The method according to claim 4, wherein a conveying speed of the further conveying unit is higher than a conveying speed of the conveying and rotating unit.

6. The method of claim 1, wherein
a plurality of first drivers and a plurality of second drivers are provided fastened on a circulating belt, and a plurality of products are conveyed simultaneously by a circulating movement of the circulating belt and their orientation is changed.

7. The method according to claim 1, wherein
the second orientation encloses an at least approximately right angle to the first orientation.

8. A conveying and rotating unit, comprising:
a driver transport unit; and
a product support configured to slide a piece-like product thereon in a predetermined conveying direction, and wherein
the driver transport unit is arranged above the product support, and comprises at least one first driver and at least one second driver which are simultaneously movable in the conveying direction and face the product support, wherein
the at least one first driver and the at least one second driver each have an active surface configured to come into contact with the product, wherein
the at least one first driver and the at least one second driver are arranged next to one another on the driver transport unit in a width direction of the product perpendicular to the conveying direction, and wherein
the first driver comprises a surface section of its active surface which is arranged offset with respect to each surface section of the active surface of the second driver in the conveying direction.

9. A conveying and rotating unit, comprising:
a driver transport unit, and
a product support, wherein
the product support is designed such that the a piece-like product slides thereon in a predetermined conveying direction, and the driver transport unit
is arranged above the product support, and
comprises at least one first driver and at least one second driver which are simultaneously movable in the conveying direction and face the product support, wherein
the at least one first driver is arranged on the driver transport unit such that it is designed, during its movement in the conveying direction, to abut against the product resting on the product support in the a first orientation in such a way that the first orientation thereof changes toward the a second orientation by introducing the a rotational impulse, and
the at least one second driver is arranged on the driver transport unit such that it is designed, during its movement in the conveying direction, to abut against at least two points lying on opposite sides, with respect to a center of the product in the second orientation, in a direction perpendicular to the conveying direction.

10. The conveying and rotating unit according to claim 8, wherein
at one end, the product support comprises a predetermined receiving region in which the product which is fed to the conveying and rotating unit rests on the product support in the first orientation, wherein a width of the receiving region is defined over a width of the product in a width direction perpendicular to the conveying direction, and
the first driver is attached to the driver transport unit such that it has a surface section abutting against the product, which surface section leads in the conveying direction and is situated in a section of the receiving region between the center in the width direction and an edge of the receiving region in the direction of a boundary of the product support, which boundary is situated closer to the receiving region, along the conveying direction.

11. The conveying and rotating unit according to claim 8, wherein the driver transport unit comprises a circulating belt on which a plurality of first drivers and a plurality of second drivers are arranged.

12. The conveying and rotating unit according to claim 8, wherein
a plurality of first drivers and a plurality of second drivers are provided, and in each case a first driver and a second driver are formed integrally.

13. The conveying and rotating unit according to claim 8, wherein
the product support has a device which is configured to provide a different frictional force between the product support and the product along the conveying direction.

14. The conveying and rotating unit according to claim 13, wherein
the device has openings in the product support.

15. A packaging plant, comprising:
the conveying and rotating unit of claim 8;
a conveying unit, which is designed to feed the product in the first orientation onto the product support, and
a further conveying unit, which is designed to receive the product in the second orientation.

16. The conveying and rotating unit according to claim 9, wherein
at one end, the product support comprises a predetermined receiving region in which the product which is fed to the conveying and rotating unit rests on the product support in the first orientation, wherein a width of the receiving region is defined over a width of the product in a width direction perpendicular to the conveying direction, and
the first driver is attached to the driver transport unit such that it has a surface section abutting against the product, which surface section leads in the conveying direction and is situated in a section of the receiving region between the center in the width direction and an edge of the receiving region in the direction of a boundary of the product support, which boundary is situated closer to the receiving region, along the conveying direction.

17. The conveying and rotating unit according to claim 9, wherein
the driver transport unit comprises a circulating belt on which a plurality of first drivers and a plurality of second drivers are arranged.

18. The conveying and rotating unit according to claim 9, wherein
a plurality of first drivers and a plurality of second drivers are provided, and in each case a first driver and a second driver are formed integrally.

19. The conveying and rotating unit according to claim 9, wherein
the product support has a device which is configured to provide a different frictional force between the product support and the product along the conveying direction.

20. The conveying and rotating unit according to claim 19, wherein
the device has openings in the product support.

21. The conveying and rotating unit according to claim 20, wherein
the openings in the product support are connected to a vacuum system.

22. A packaging plant, comprising:
the conveying and rotating unit of claim 9;
a conveying unit, which is designed to feed the product in the first orientation onto the product support, and
a further conveying unit, which is designed to receive the product in the second orientation.

23. The method according to claim 3, wherein
the frictional force is adjustable along a conveying distance on the product support.

24. The conveying and rotating unit according to claim 8, wherein
the surface section of the active surface of the first driver lies in front of each surface section of the active surface of the second driver in the conveying direction.

25. The conveying and rotating unit according to claim 14, wherein
the openings in the product support are connected to a vacuum system.
